(19) United States
(12) Patent Application Publication
(10) Pub. No.: US 2024/0320728 A1
(43) Pub. Date: Sep. 26, 2024

(54) PRODUCT RECOMMENDATION METHOD, TERMINAL DEVICE, AND PRODUCT RECOMMENDATION SYSTEM

(71) Applicant: CASIO COMPUTER CO., LTD., Tokyo (JP)

(72) Inventors: Noritaka KOMIYAMA, Tokyo (JP); Yoshihiro TAKAYAMA, Tokyo (JP)

(73) Assignee: CASIO COMPUTER CO., LTD., Tokyo (JP)

(21) Appl. No.: 18/613,331

(22) Filed: Mar. 22, 2024

(30) Foreign Application Priority Data
Mar. 24, 2023 (JP) 2023-049065

(51) Int. Cl. G06Q 30/0601

(52) U.S. Cl. CPC G06Q 30/0631; G06Q 30/0625

(57) ABSTRACT

A product recommendation method executed by a computer, the computer comprising: a memory storing a program; and at least one processor that executes the program, wherein the at least one processor acquires, for plurality of products, product data including a tag expressing a feature of each product; identifies a relevant product that is relevant to a user in response to a display request or an update request of a predetermined screen from the user; searches the product data and extracts the tag attached to the relevant product; extracts, based on the extracted tag, a candidate group of products to be recommended to the user; and determines whether the extracted candidate group satisfies a predetermined condition in order to identify a product to display on the predetermined screen.

### CROSS-REFERENCE TO RELATED APPLICATIONS

This application claims the benefit of Japanese Patent Application No. 2023-049065, filed on Mar. 24, 2023, the entire disclosure of which is incorporated by reference herein.

### FIELD OF THE INVENTION

The present application relates generally to a product recommendation method, a terminal device, and a product recommendation system.

### BACKGROUND OF THE INVENTION

When a user purchases a product or views products on an e-commerce site or the like via the internet, the user is presented with other products thought to match the preferences of the user. Such presented products are so-called “recommended products.” For example, International Publication No. WO 2020/085086 describes a product recommendation system that extracts recommended products on the basis of user attribute information and tags attached to products purchased by the user and displays the extracted recommended products on a terminal.

### SUMMARY OF THE INVENTION

A product recommendation method according to the present disclosure is a product recommendation method executed by a computer,
the computer comprising:
a memory storing a program; and
at least one processor that executes the program, wherein
the at least one processor
acquires, for plurality of products, product data including a tag expressing a feature of each product;
identifies a relevant product that is relevant to a user in response to a display request or an update request of a predetermined screen from the user;
searches the product data and extracts the tag attached to the relevant product;
extracts, based on the extracted tag, a candidate group of products to be recommended to the user; and
determines whether the extracted candidate group satisfies a predetermined condition in order to identify a product to display on the predetermined screen.

### BRIEF DESCRIPTION OF DRAWINGS

A more complete understanding of this application can be obtained when the following detailed description is considered in conjunction with the following drawings, in which:

FIG. 1 is a drawing illustrating the overall configuration of a product recommendation system according to an embodiment of the present disclosure;

FIG. 2 is a block diagram illustrating the configuration of a user terminal according to an embodiment of the present disclosure;

FIG. 3 is a block diagram illustrating the configuration of a server according to an embodiment of the present disclosure;

FIG. 4 is a drawing illustrating a configuration example of user data stored in a user database according to an embodiment of the present disclosure;

FIG. 5 is a drawing illustrating a configuration example of product data stored in a product database according to an embodiment of the present disclosure;

FIG. 6 is a flowchart of menu screen display processing according to an embodiment of the present disclosure; and

FIG. 7 is a drawing illustrating an example of a menu screen according to an embodiment of the present disclosure.

### DETAILED DESCRIPTION OF THE INVENTION

Hereinafter, a product recommendation system, a product recommendation method, and a program according to embodiments of the present disclosure are described in detail while referencing the drawings. Note that, in the drawings, identical or corresponding components are denoted with the same reference numerals.

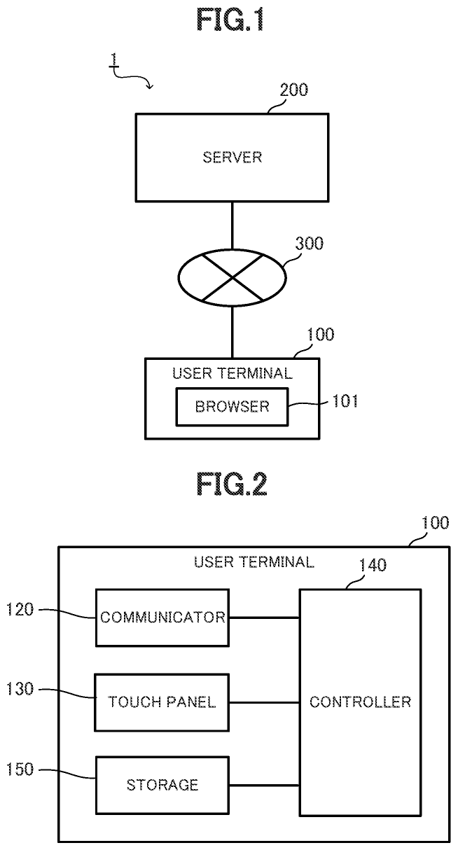

Hereinafter, a product recommendation system 1 according to an embodiment of the present disclosure is described. The product recommendation system 1 is a system for introducing specific products to a user. The user can purchase the introduced products via the product recommendation system 1. As illustrated in FIG. 1, the product recommendation system 1 includes a user terminal 100 that is used by the user, and a server 200 that provides a product introduction site. The user terminal 100 and the server 200 are communicably connected to each other across an internet 300, which is an example of a communication network.

The user terminal 100 is a smartphone, a tablet terminal, or the like that is used by the user. A browser 101 is installed on the user terminal 100, and the user can search for, view, purchase, and the like products by accessing, via the browser 101, the product introduction site provided by server 200. As illustrated in FIG. 2, the user terminal 100 includes a communicator 120, a touch panel 130, a controller 140, and a storage 150.

The communicator 120 is an interface whereby the user terminal 100 communicates with the server 200 across the internet 300.

The touch panel 130 is a device that has both a function of displaying various types of information on a screen and a function as a pointing device that operates a pointer on the screen. In one example, the touch panel 130 displays a menu screen on which recommended products are displayed. Additionally, the touch panel 130 receives touch operations of the user from the menu screen.

The controller 140 includes a central processing unit (CPU), read-only memory (ROM) that stores programs such as an operating system (OS) and the like, random access memory (RAM) that serves as the working area, and the like, and controls the entire user terminal 100. Note that, the controller 140 may comprise a plurality of processers.

The storage 150 has a role as a so-called secondary storage device (auxiliary storage device) and, in one example, is implemented as read/write non-volatile flash memory, a hard disk drive, or the like. Various types of data and programs to be executed by the controller 140 are stored in the storage 150.

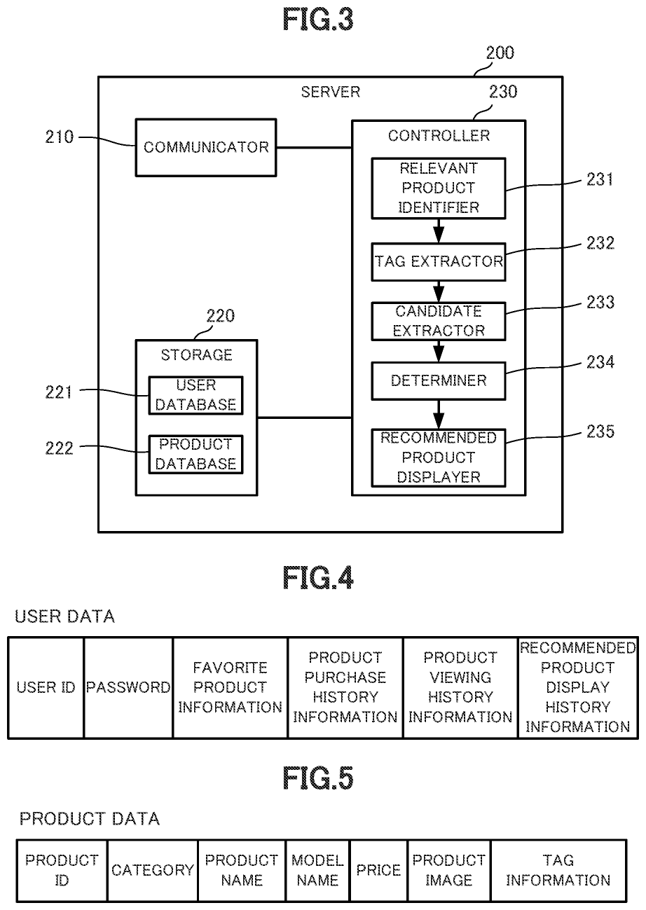

Returning to FIG. 1, the server 200 is a web server of the product introduction site. In response to requests from the user terminal 100, the server 200 displays various types of screens on the browser 101 of the user terminal 100, executes various types of processings, and the like. As illustrated in FIG. 3, the server 200 includes a communicator 210, a storage 220, and a controller 230.

The communicator 210 is an interface for communicating with the user terminal 100 across the internet 300.

The storage 220 has a role as a so-called secondary storage device (auxiliary storage device) and, in one example, is implemented as read/write non-volatile flash memory, a hard disk drive, or the like. Various types of data and programs to be executed by the controller 230 are stored in the storage 220. In one example, a user database 221, and a product database 222 are stored in the storage 220.

The user database 221 is a database in which user data, of each user registered as a member of the product recommendation system 1, is stored. As illustrated in FIG. 4, the user data includes a user ID, a password, favorite product information, product purchase history information, product viewing history information, recommended product display history information, and the like of the user. The favorite product information indicates products that the user has marked as favorites of the user. The product purchase history information indicates a purchase history of products purchased by the user on the product recommendation system 1. The product viewing history information indicates a viewing history of products viewed by the user on the product recommendation system 1. The recommended product display history information indicates a display history of products displayed to the user on the menu screen as recommended products.

The product database 222 is a database in which product data of each product handled by the product recommendation system 1 is stored. As illustrated in FIG. 5, the product data includes a product ID of the product, a category to which that product belongs, a product name, a model name, a price, a product image, a tag, and the like. The tag is information expressing a feature of that product. Various tags are prepared in advance. Examples of the tag include tags expressing the color of the product such as “red” and “black”, tags expressing the target user of the product such as “young people” and “old people”, and tags expressing seasons that represent an image of the product such as “spring” and “summer”. Additionally, product data of products that are not currently for sale is also stored in the product database 222. The product database 222 is an example of a product storage of the present disclosure.

Returning to FIG. 3, the controller 230 includes a CPU, a ROM that stores programs such as an OS, a RAM that serves as the working area, and the like. Note that, the controller 230 may comprise a plurality of processors. The controller 230 controls the entire server 200. Additionally, the controller 230 includes, as a functional configuration according to the present embodiment, a relevant product identifier 231, a tag extractor 232, a candidate extractor 233, a determiner 234, and a recommended product displayer 235.

The relevant product identifier 231 identifies products (relevant products) that are relevant to the user when there is an access from the user (the user terminal 100) and displaying of the menu screen is requested. The relevant products are, for example, products that the user has marked as favorites, products that the user has purchased or viewed in the past, or the like.

The tag extractor 232 searches the product data stored in the product database 222 and extracts the tags attached to the relevant products.

The candidate extractor 233 extracts, on the basis of the extracted tags, a candidate group of products to be recommended to the user. Specifically, the candidate extractor 233 totals the extracted tags by type and, when there is a type of tag (a piece of specific information expressing a feature of the product) attached a predetermined number or greater, namely, a frequently appearing tag, the candidate extractor 233 extracts, as the candidate group, the various products to which that frequently appearing tag is attached.

The determiner 234 determines whether the candidate group extracted by the candidate extractor 233 satisfies a predetermined condition in order to identify the products to be displayed on the menu screen. Here, examples of the predetermined condition include a condition that the number of products included in the candidate group is greater than or equal to a predetermined number, a condition that the number of the products, included in the candidate group, that have not been displayed yet as recommended products is greater than or equal to a predetermined number, and the like.

The recommended product displayer 235 displays the recommended products on the menu screen on the basis of determination results of the determiner 234. In one example, when the determiner 234 determines that the candidate group satisfies the predetermined condition, the recommended product displayer 235 displays, on the browser 101 of the user terminal 100, a menu screen in which the products included in the candidate group are displayed as the recommended products. Meanwhile, when the determiner 234 determines that the candidate group does not satisfy the predetermined condition, the recommended product displayer 235 displays, on the menu screen, products other than the products included in the candidate group as the recommended products.

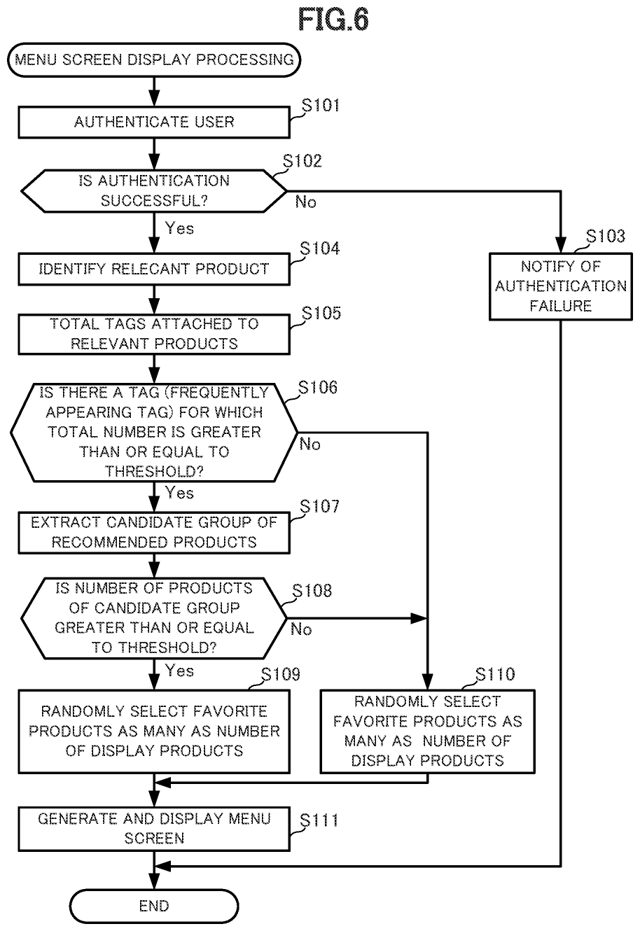

Next, the operations of the server 200 are described. In one example, a user performs an operation for accessing the product introduction site by touching a shortcut icon of the product introduction site displayed on the touch panel 130 of the user terminal 100. In response to this operation, the controller 140 of the user terminal 100 sends, to the server 200, an access request including the user ID and the password of that user. When the access request is received from the user terminal 100, the controller 230 of the server 200 executes menu screen display processing illustrated in FIG. 6.

Firstly, the controller 230 of the server 200 performs authentication of the user (step S101). Specifically, the controller 230 confirms that the user data, including the user ID and the password, included in the received access request is stored in the user database 221.

When the authentication of the user fails (step S102; No), the controller 230 notifies the user terminal 100 of the failure (step S103), and the menu screen display processing is ended.

Meanwhile, when the authentication of the user is successful (step S102; Yes), the controller 230 (the relevant product identifier 231) identifies products relevant to the user (relevant products) (step S104). Specifically, the controller 230 identifies, as the relevant products, products that the user has marked as favorites and/or products that the user has purchased or viewed on the product recommendation system 1. The controller 230 performs this identification on the basis of the favorite product information, the product purchase history information, and the product viewing history information included in the user data of the user that is stored in the user database 221 and for which the authentication is successful.

Next, the controller 230 (the tag extractor 232) references the product database 222 and totals, by type, the tags attached to the relevant products identified in step S104 (step S105). Then, the controller 230 (the tag extractor 232) determines whether there is a tag for which the total number of each type is greater than or equal to a threshold (for example, 3 or greater) (step S106). In the following description, tags for which the total number is greater than or equal to the threshold are also referred to as “frequently appearing tags”.

When there is a frequently appearing tag (step S106; Yes), the controller 230 (the candidate extractor 233) searches the product database 222 and extracts, as a candidate group of recommended products, various products to which the frequently appearing tag is attached (step S107). Here, when there is a plurality of frequently appearing tags, the controller 230 extracts, as the candidate group, various products to which even one frequently appearing tag is attached. For example, when there are “red”, “summer”, and “young people” as frequently appearing tags, the controller 230 extracts, as the candidate group, various products to which at least one of the frequently appearing tags “red”, “summer”, and “young people” is attached. Note that when, among the products to which the frequently appearing tag are attached, there is a product that matches the relevant product identified in step S104, it is desirable that this product is excluded from the candidate group. This is because such products are already known to the user and displaying such products as the recommended products is unnecessary.

Next, the controller 230 (the determiner 234) determines whether the number of products included in the candidate group extracted in step S107 is greater than or equal to a threshold (for example, 30) (step S108). It is desirable that this threshold is set to a number several times the number of recommended products that is to be displayed on the menu screen (hereinafter referred to as “number of display products”), the number being predetermined.

When the number of products included in the candidate group is greater than or equal to the threshold (step S108; Yes), the controller 230 (the recommended product displayer 235) randomly selects, from among the candidate group, the same number of products as the number of display products (for example, 10) as favorite products (step S109). Then, the processing of step S111 is executed.

Meanwhile, when there are no frequently appearing tags in step S106 (step S106; No), or when the number of products included in the candidate group is less than 30 (step S108; No), the controller 230 (the recommended product displayer 235) randomly selects, from the various products for which product data is stored in the product database 222, the same number of products as the number of display products as favorite products (step S110). Then, the processing of step S111 is executed.

In step S111, the controller 230 (the recommended product displayer 235) generates screen data of a menu screen that displays, as the recommended products, the products selected in step S109 or S110, and displays the generated screen data on the screen of the browser 101 of the user terminal 100 (step S111). Note that, here, the controller 230 appropriately updates the recommended product display history information of the user data, corresponding to this user, registered in the user database 221.

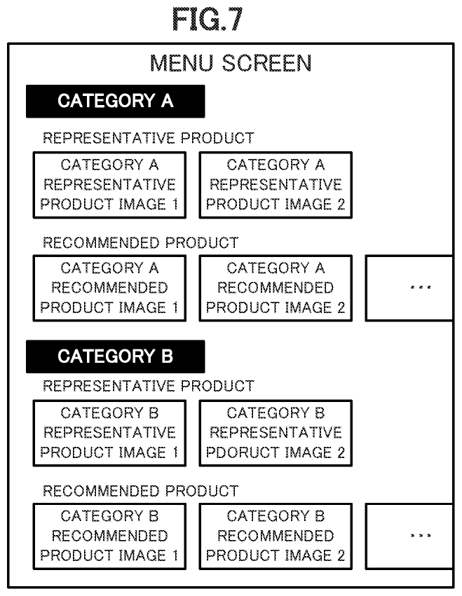

FIG. 7 illustrates an example of the menu screen to be displayed on the browser 101 of the user terminal 100 in step S111. In this menu screen, for each of two categories selected randomly from among a plurality of categories, namely category A and category B, images of ten products selected, in step S109 or step S110, from among products belonging to each category are displayed as recommended products. Additionally, for each category, a representative product that is set in advance as a product representing that category is also displayed in this menu screen. Note that, in this menu screen, only two recommended products are displayed for each category, but the user can swipe left and right to scroll the menu screen, thereby making it possible to display the other eight recommended products. Additionally, the user can click the image portion of a favorite product to transition to a detail screen of that product and purchase that product, or the like. Moreover, the user can flick the menu screen downward to re-execute the menu screen display processing and update the displayed recommended products. Note that a configuration is possible in which products selected from among all of the products are displayed on the menu screen without displaying in separate categories. Then, the menu screen display processing is ended.

With product recommendation systems that use conventional technology, the recommended products are extracted on the basis of tags attached to products that the user has purchased. Consequently, as long as the user does not make a new purchase of a product, the displayed lineup of recommended products does not significantly change. In many cases, users access e-commerce sites without purchasing any products and, in such cases, with product recommendation systems that use conventional technology, the same recommended products are displayed every time, a sense of freshness is lacking, and effects of enhancing the purchasing intention of the user and effects of increasing opportunities for the user to get to know products previously unknown to the user cannot be expected. Consequently, there is a problem of not being able to maintain the interest of the user. In contrast, according to the present embodiment, in cases in which the number of products included in the candidate group of products, extracted on the basis of tags attached to relevant products that are relevant to the user, is greater than or equal a threshold, the products included in the candidate group are displayed as the recommended products. In cases in which the number of the products included in the candidate group is greater than or equal to the threshold, when the products to be displayed are randomly selected from among the candidate group, the user is less likely to have an impression that the same products are being displayed every time. Moreover, products aligned with the preferences of the user are mainly displayed and, as such, it is possible to suppress decreases in the purchasing intention of the user. Meanwhile, when the number of the products included in the candidate group is less than the threshold, products other than the candidate group are also displayed as the recommended products. In cases in which the number of the products included in the candidate group is less than the threshold, when the products to be displayed are randomly selected from among the candidate group, the user may have an impression that the same products are being displayed every time. To address this, when the number of the products included in the candidate group is less than the threshold, products other than the candidate group are also displayed as the recommended products and, as a result, even when there are few products extracted on the basis of the tags, the lineup of products to be displayed as the recommended products can be changed every time, displaying with a sense of freshness can be performed, and opportunities to introduce the user to products that the user may not be aware of can be increased while avoiding causing the user to lose interest. As a result, it is possible to maintain the interest of the user in the products.

### Modified Examples

Various modifications can be made to the embodiment described above. For example, in the embodiment described above, a display method of recommended products when initially displaying a menu screen is described, but it is possible to update the displaying of the recommended products using the same technique when updating the menu screen as well. In the embodiment described above, the recommended products are displayed on the menu screen initially displayed when the product introduction site is accessed, but the screen on which the recommended products are displayed is not limited to the menu screen. For example, a configuration is possible in which the recommended products are displayed, using the same display technique, on screens such as a product viewing screen, a product purchase screen, or the like.

In the embodiment described above, the controller 230 of the server 200 executes the menu screen display processing, but a configuration is possible in which the controller 140 of the user terminal 100 executes this processing. In such a case, at the start of the processing, the user terminal 100 must access the server 200 and copy the user database 221 and the product database 222 to the storage 150 of the user terminal 100.

In the embodiment described above, the controller 230 (the relevant product identifier 231) identifies, as the relevant products, products that the user has marked as favorites and/or products that the user has purchased or viewed on the product recommendation system 1. The controller 230 performs this identification on the basis of the favorite product information, the product purchase history information, and the product viewing history information included in the user data, of the user of the user terminal 100, stored in the user database 221. However, this is merely an example, and a configuration is possible in which the controller 230 identifies the relevant products on the basis of the favorite product information, the product purchase history information, and the product viewing history information included in the user data, of all of the users, stored in the user database 221. Specifically, a configuration is possible in which, of the products that the various users have set as favorites, a predetermined number (for example, 10) of products, in descending order of the number of users that have set the products as favorites, are identified as the relevant products. Alternatively, a configuration is possible in which, of the products that the various users have purchased from the product recommendation system 1, a predetermined number (for example, 10) of products, in descending order of the number of users that have purchased the products, are identified as the relevant products. Alternatively, a configuration is possible in which, of the products that the various users have viewed on the product recommendation system 1, a predetermined number (for example, 10) of products, in descending order of the number of users that have viewed the products, are identified as the relevant products. With such a configuration, the relevant products can be identified and the recommended products can be displayed even when the favorite product information, the product purchase history information, and the product viewing history information of the user of the user terminal 100 are not yet stored in the user database 221 (for example, when the user uses the product recommendation system 1 for the first time).

In the embodiment described above, the controller 230 (the recommended product displayer 235) randomly selects, from among the candidate group, products corresponding to the number of display products as the favorite products, but a configuration is possible in which the controller 230 (the recommended product displayer 235) selects, from among the candidate group, products to which frequently appearing tags, having greater total numbers, are attached with priority as the favorite products, with the number of display products as the upper limit. With such a configuration, the purchasing intention of the user can be enhanced.

The method for extracting the favorite products in the menu screen display processing is not limited to the method described in the embodiment described above. For example, a configuration is possible in which, in the menu screen display processing, when a determination is made that the predetermined condition, that the number of products included in the extracted candidate group is greater than or equal to the threshold, is not satisfied, at least one product other than the products included in the candidate group is displayed on the menu screen as the recommended product.

Additionally, for example, a configuration is possible in which, in the menu screen display processing, when a determination is made that the predetermined condition, that the number of products included in the extracted candidate group is greater than or equal to the threshold, is satisfied, products other than the products included in the candidate group are not displayed on the menu screen as the recommended products.

Additionally, for example, a configuration is possible in which, in the menu screen display processing, when a determination is made that the predetermined condition, that the number of products included in the extracted candidate group is greater than or equal to the threshold, is not satisfied, more products from the products not included in the candidate group are displayed on the menu screen as the recommended products than when a determination is made that the predetermined condition is satisfied.

A computer may be configured that is capable of realizing the various features described above by storing and distributing a program for realizing the various features of the server on a non-transitory computer-readable recording medium such as a compact disc read-only memory (CD-ROM), a digital versatile disc read-only memory (DVD-ROM), or the like, and installing this program on the computer. Moreover, in cases in which the various functions are realized by being divided between an operating system (OS) and an application, or are realized by cooperation between an OS and an application, it is possible to store only the application on the non-transitory recording medium.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A product recommendation method executed by a computer,
the computer comprising:
a memory storing a program; and
at least one processor that executes the program, wherein
the at least one processor
acquires, for plurality of products, product data including a tag expressing a feature of each product;
identifies a relevant product that is relevant to a user in response to a display request or an update request of a predetermined screen from the user;
searches the product data and extracts the tag attached to the relevant product;
extracts, based on the extracted tag, a candidate group of products to be recommended to the user; and
determines whether the extracted candidate group satisfies a predetermined condition in order to identify a product to display on the predetermined screen.

2. The product recommendation method according to claim 1, wherein in a case in which the at least one processor determines that the extracted candidate group does not satisfy the predetermined condition, the at least one processor displays at least one product other than the products included in the candidate group on the predetermined screen as a recommended product.

3. The product recommendation method according to claim 1, wherein in a case in which the at least one processor determines that the extracted candidate group satisfies the predetermined condition, the at least one processor does not display a product other than the products included in the candidate group on the predetermined screen as a recommended product.

4. The product recommendation method according to claim 1, wherein in a case in which the at least one processor determines that the extracted candidate group satisfies the predetermined condition, the at least one processor displays the products included in the candidate group on the predetermined screen as recommended products and, in a case in which the at least one processor determines that the extracted candidate group does not satisfy the predetermined condition, the at least one processor displays a product other than the products included in the candidate group on the predetermined screen as the recommended product.

5. The product recommendation method according to claim 1, wherein in a case in which the at least one processor determines that the extracted candidate group does not satisfy the predetermined condition, the at least one processor displays more products from products not included in the candidate group on the predetermined screen as recommended products than in a case in which the at least one processor determines that the extracted candidate group satisfies the predetermined condition.

6. The product recommendation method according to claim 1, wherein the predetermined condition is a condition that a number of the products included in the candidate group is greater than or equal to a predetermined number.

7. The product recommendation method according to claim 1, wherein the predetermined condition is a condition that, among the products included in the candidate group, a number of products that have not yet been displayed as recommended products is greater than or equal to a predetermined number.

8. The product recommendation method according to claim 1, wherein the at least one processor totals the extracted tag by type, identifies a frequently appearing tag for which a total number is greater than or equal to a predetermined number, and extracts various products to which at least one of the identified frequently appearing tag is attached as the candidate group.

9. The product recommendation method according to claim 1, wherein the at least one processor identifies at least one of a product that the user has set as a favorite and a product that the user has purchased or viewed as the relevant product.

10. A terminal device comprising:
a memory storing a program; and
at least one processor that executes the program, wherein
the at least one processor
acquires, for plurality of products, product data including a tag expressing a feature of each product;
identifies a relevant product that is relevant to a user in response to a display request or an update request of a predetermined screen from the user;
searches the product data and extracts the tag attached to the relevant product;
extracts, based on the extracted tag, a candidate group of products to be recommended to the user; and
determines whether the extracted candidate group satisfies a predetermined condition in order to identify a product to display on the predetermined screen.

11. The terminal device according to claim 10, further comprising:
a display, wherein
in a case in which a determination is made that the extracted candidate group does not satisfy the predetermined condition, the at least one processor displays the predetermined screen on the display, with at least one product other than the products included in the candidate group as a recommended product.

12. The terminal device according to claim 10, further comprising:
a display, wherein
in a case in which a determination is made that the extracted candidate group satisfies the predetermined condition, the at least one processor does not display the predetermined screen on the display, with a product other than the products included in the candidate group on the display as a recommended product.

13. The terminal device according to claim 10, further comprising:
a display, wherein
in a case in which a determination is made that the extracted candidate group satisfies the predetermined condition, the at least one processor displays the predetermined screen on the display, with the products included in the candidate group as recommended products and, in a case in which a determination is made that the extracted candidate group does not satisfy the predetermined condition, the at least one processor displays the predetermined screen on the display, with a product other than the products included in the candidate group as the recommended product.

14. The terminal device according to claim 10, further comprising:
a display, wherein
in a case in which a determination is made that the extracted candidate group does not satisfy the predetermined condition, the at least one processor displays the predetermined screen on the display, with more products from products not included in the candidate group as recommended products than in a case in which a determination is made that the extracted candidate group satisfies the predetermined condition.

15. The terminal device according to claim 10, wherein the predetermined condition is a condition that a number of the products included in the candidate group is greater than or equal to a predetermined number.

16. The terminal device according to claim 10, wherein the predetermined condition is a condition that, among the products included in the candidate group, a number of products that have not yet been displayed as recommended products is greater than or equal to a predetermined number.

17. The terminal device according to claim 10, wherein the at least one processor totals the extracted tag by type, identifies a frequently appearing tag for which a total number is greater than or equal to a predetermined number, and extracts, as the candidate group, various products to which at least one of the identified frequently appearing tag is attached.

18. The terminal device according to claim 10, wherein the at least one processor identifies, as the relevant product, at least one of a product that the user has set as a favorite, and a product that the user has purchased or viewed.

19. A product recommendation system comprising:
a first device; and
a second device, wherein
the first device includes
a first memory that stores, for plurality of products, a first program and product data including a tag that expresses a feature of each product,
a first communication interface capable of communicating with the second device, and
at least one first processor that executes the first program,
the second device includes
a second memory storing a second program,
a second communication interface capable of communicating with the first device,
a display, and
at least one second processor that executes the second program,
the at least one first processor of the first device
identifies a relevant product that is relevant to a user in response to receiving a display request or an update request of a predetermined screen from the user via the first communication interface,
searches the product data and extracts the tag attached to the relevant product,
extracts, based on the tag, a candidate group of products to be recommended to the user, and
in a case in which a determination is made that the candidate group does not satisfy a predetermined condition, sets at least one product other than the products included in the candidate group as a recommended product, and sends information related to the recommended product to the second device via the first communication interface, and
the at least one second processor of the second device displays the predetermined screen on the display in response to receiving the information related to the recommended product from the second communication interface.
